(19) United States
(12) Patent Application Publication
(10) Pub. No.: US 2025/0392469 A1
(43) Pub. Date: Dec. 25, 2025

(54) Systems and Methods for Video Authentication

(71) Applicant: Rekor Systems, Inc., Columbia, MD (US)

(72) Inventors: Christopher Allen KADOCH, Leesburg, VA (US); Kurt Allen KESSEL, Senoia, GA (US)

(21) Appl. No.: 19/244,817

(22) Filed: Jun. 20, 2025

Related U.S. Application Data
(63) Continuation of application No. PCT/US2025/334501, filed on Jun. 20, 2025.
(60) Provisional application No. 63/662,977, filed on Jun. 21, 2024.

(51) Int. Cl. H04L 9/32

(52) U.S. Cl. CPC H04L 9/3236

(57) ABSTRACT

An image data validation system includes an image source that captures an image of an object and generates, from the captured image, image data and associated metadata. The metadata stores a first unique identifier generated by applying a cryptographic function to the image data. The system also includes an image recipient that receive the image data and the metadata from the image source and generates a second unique identifier from the image data by applying the cryptographic function to the image data. The recipient validates the image data as having not been altered by comparing the first unique identifier to the second unique identifier.

### CROSS-REFERENCE TO RELATED APPLICATIONS

This application is a continuation of PCT Application No. PCT/US25/334501, filed Jun. 20, 2025, which claims the benefit of U.S. Provisional Application No. 63/662,977, filed Jun. 21, 2024, the entire disclosures of which is expressly incorporated by reference herein. This application also claims the benefit of U.S. Provisional Application No. 63/662,977, filed Jun. 21, 2024, the entire disclosure of which is expressly incorporated by reference herein.

### BACKGROUND

The present invention relates to systems and methods for the authentication of digital video, and more particularly to systems and methods for authenticating digital video in traffic monitoring systems.

It is commonplace that digital video/images are often used as evidence of the occurrence of the events they record. At a high-level, a video file is made up of individual image frames that contain what amounts to a picture, audio, and metadata, which are displayed to a user in quick succession as the video.

Recently, artificial intelligence generated video/images and “deep fakes” have reached a level of quality and realism that makes it difficult to distinguish between authentic video/images and those generated artificially. The reliability of digital video/images as evidence is therefore becoming increasingly suspect.

There have been various attempts to validate the authenticity of digital video/images by examining video/images at the pixel level to identify “clues” that the video/image is not authentic. While such approaches may have been sufficient for low-quality fake video/images, those same approaches fail with increasing frequency as the quality of the fake video/images improves.

It is therefore desirable to digitally “sign” video/images during the initial recording and thereafter, e.g., during playback, validate the digital “signature” to ensure authenticity of the video/images.

### BRIEF SUMMARY OF THE INVENTION

Systems and methods are disclosed for the authentication of digital video frames, clips and files. Other objects, advantages and novel features of the present invention will become apparent from the following detailed description of one or more preferred embodiments when considered in conjunction with the accompanying drawings. It should be recognized that the one or more examples in the disclosure are non-limiting examples and that the present invention is intended to encompass variations and equivalents of these examples.

### BRIEF DESCRIPTION OF THE DRAWINGS

The features, objects, and advantages of the present invention will become more apparent from the detailed description, set forth below, when taken in conjunction with the drawings, in which like reference characters identify elements correspondingly throughout.

FIG. 1 illustrates an exemplary system in accordance with at least one embodiment;

FIG. 2 illustrates exemplary video frames and video clips in accordance with at least one embodiment;

FIG. 3 illustrates an exemplary method in accordance with at least one embodiment; and

FIG. 4 illustrates an exemplary method in accordance with at least one embodiment.

### DETAILED DESCRIPTION OF THE PREFERRED EMBODIMENTS

The above described drawing figures illustrate the present invention in at least one embodiment, which is further defined in detail in the following description. Those having ordinary skill in the art may be able to make alterations and modifications to what is described herein without departing from its spirit and scope. While the present invention is susceptible of embodiment in many different forms, there is shown in the drawings and will herein be described in detail at least one preferred embodiment of the invention with the understanding that the present disclosure is to be considered as an exemplification of the principles of the present invention, and is not intended to limit the broad aspects of the present invention to any embodiment illustrated.

In accordance with the practices of persons skilled in the art, the invention is described below with reference to operations that are performed by a computer system or a like electronic system. Such operations are sometimes referred to as being computer-executed. It will be appreciated that operations that are symbolically represented include the manipulation by a processor, such as a central processing unit, of electrical signals representing data bits and the maintenance of data bits at memory locations, such as in system memory, as well as other processing of signals. The memory locations where data bits are maintained are physical locations that have particular electrical, magnetic, optical, or organic properties corresponding to the data bits.

When implemented in software, code segments perform certain tasks described herein. The code segments can be stored in a processor readable medium. Examples of the processor readable mediums include an electronic circuit, a semiconductor memory device, a read-only memory (ROM), a flash memory or other non-volatile memory, a floppy diskette, a CD-ROM, an optical disk, a hard disk, etc.

In the following detailed description and corresponding figures, numerous specific details are set forth in order to provide a thorough understanding of the present invention. However, it should be appreciated that the invention may be practiced without such specific details. Additionally, well-known methods, procedures, components, and circuits have not been described in detail.

The present invention generally relates to systems and methods for authenticating captured video clips, and more particularly to such systems and methods for authenticating captured video clips in traffic monitoring systems.

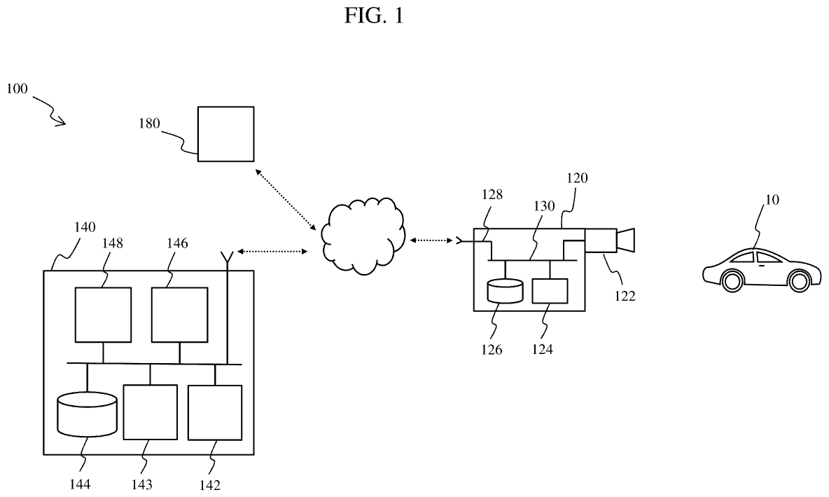

FIG. 1 is a schematic representation of a traffic monitoring system 100 in accordance with one or more aspects of the invention. As shown in FIG. 1, the traffic monitoring system 100 comprises one or more traffic sensors 120 communicatively coupled to a system server 140, via a network 160. The system server may also be communicatively coupled to one or more user devices 180 via the network 160. The traffic monitoring system 100 generally enables the collection of traffic related data for transmission, via the network 106, to the system server 140. The traffic monitoring system 100 also generally enables user access to the traffic related data stored on the system server 140, via the coupled user devices 180.

The traffic sensors 120 may each comprise an imaging device 122, a controller 124, a memory 126, and a transceiver 128, each communicatively coupled to a common data bus 130 that enables data communication between the respective components.

The imaging device 122 may capture images of traffic, in particular, video images of vehicles 10 making up the traffic, and generates video data therefrom. The imaging device 122 may be a video camera of any camera type, which captures video images suitable for computerized image recognition of objects within the captured images. For example, the camera may utilize charge-coupled-device (CCD), complementary metal-oxide-semiconductor (CMOS) and/or other imaging technology, to capture standard, night-vision, infrared, and/or other types of images, having predetermined resolution, contrast, color depth, and/or other image characteristics. The video data may be timestamped so as to indicate the date and time of recording. The video data may further include other identifying information, including geolocation data and/or traffic sensor ID data. It will be understood that, while the invention is described herein with respect to video data, still image data may be similarly used, or may be otherwise generated from the video data, without departing from the scope of the invention.

The controller 124 may be generally configured to control the imaging device 122, the memory 126, and the transceiver 128, in accordance with the functions described herein. In at least one embodiment, the controller 124 may execute image processing software for applying image processing to the video data captured by the imaging device 122 so as to generate processed video data. Some exemplary types of image processing that may be applied to the video data include image enhancement, encoding, compression, and recognition processing.

In some embodiments, the controller 124 may generate one or more recognition records from the processed video data. The recognition records are datasets comprising one or more values reflecting image recognized vehicle and/or traffic characteristics. These characteristic values may be associated with corresponding confidence scores indicating the confidence with which the particular characteristic value was determined.

Accordingly, in some embodiments, the controller 124 may apply computerized image recognition techniques to identify objects within the video images. For example, the controller 124 may identify individual vehicles captured by the video images, as well as their associated characteristics. These vehicle characteristics may include, for example, vehicle type, class, make, model, color, year, drive type (e.g., electric, hybrid, etc.), license plate number, registration, trajectory, speed, location, etc., or any combination thereof. The controller 124 may also apply image analysis techniques to the image-recognized video images so as to identify captured traffic characteristics. These traffic characteristics may include, for example, temporal histories, vehicle counts, congestion levels, the presence of accidents, disabled vehicles, foreign objects, or other traffic incidents, or any combination thereof.

The recognition record may also include some or all of the processed video data. The included processed video data may be low-resolution or low-bit video data and/or limited frame video data. That is, the included processed video data may be of lower resolution/bit and/or more limited in frames than the source video data from which it is generated. In some embodiments, the recognition record comprises the processed video data having metadata that includes the dataset with one or more of the characteristic values discussed herein.

The recognition record may still also include the identifier (e.g., timestamp, geolocation data, sensor ID, etc.) associated with the corresponding video data from which it was generated. Accordingly, the identifier may be used to identify the video data corresponding to the recognition record.

In at least one embodiment, the controller 124 may execute image authentication software for applying image authentication processing to the video data captured by the imaging device 122 so as to generate the processed video data. As discussed herein, the image authentication processing may comprise applying a cryptographic function (e.g., a hash function) to the video data to generate a first unique identifier (e.g., a first hash value) that may be stored in the metadata of the video data.

The controller 124 may be embodied, collectively or individually, as one or more processors programmed to carry out the functions described herein in accordance with software stored in the memory 126. Each processor may be a standard processor, such as a central processing unit (CPU), or a dedicated processor, such as an application-specific integrated circuit (ASIC) or field programable gate array (FPGA), or portion thereof.

The memory 126 stores software and data that can be accessed by the processor(s), and includes both transient and persistent storage. The transient storage is configured to temporarily store data being processed or otherwise acted on by other components, and may include a data cache, RAM or other transient storage types. The persistent storage is configured to store software and data until deleted. The memory 126 is accordingly configured to store the software, data and information described herein.

The transceiver 128 communicatively couples the traffic sensor 120 to the network 160 so as to enable data transmission therewith. In particular, the transceiver 128 may be configured to transmit the processed video data and/or the recognition records to the system server 140 via the network 160.

The network 160 may be any type of network, wired or wireless, configured to facilitate the communication and transmission of data, instructions, etc., and may include a local area network (LAN) (e.g., Ethernet or other IEEE 802.03 LAN technologies), Wi-Fi (e.g., IEEE 802.11 standards, wide area network (WAN), virtual private network (VPN), global area network (GAN)), a cellular network, or any other type of network or combination thereof.

The system server 140 may include one or more server computers connected to the network. Each server computer may include computer components, including one or more processors, memories, displays and interfaces, and may also include software instructions and data for executing the functions of the server described herein. The servers may also include one or more storage devices 144 configured to store large quantities of data and/or information, and may further include one or more databases. For example, the storage device may be a collection of storage components, or a mixed collection of storage components, such as ROM, RAM, hard-drives, solid-state drives, removable drives, network storage, virtual memory, cache, registers, etc., configured so that the server computers may access it. The storage devices may also support one or more databases for the storage of data therein.

The system server 140 is generally configured to provide centralized support for the traffic sensors 120. The system server 140 is configured to receive traffic sensor generated data (e.g., video and other data) from each of the traffic sensors 120, and to store the data for users to access via the user devices 180. The system server 140 may therefore include one or more databases configured to store the data received from the traffic sensors 120.

In at least one embodiment, the system server 140 comprises an analysis engine 142, which may be generally configured to analyze the traffic sensor generated data to generate vehicle and/or traffic metrics for various periods of time. The metrics may be generated via statistical analysis of the historical data, or by comparison of the historical data with secondary data sets (e.g., manufacturer identified weight, emissions, etc. of make/model), or any combination thereof. The metrics may be, for example, vehicle tonnage, emissions, drive types, number, etc., over a section of the roadway per period of time.

In at least one embodiment, the system server 140 comprises an image authentication engine 143 configured to apply image authentication processing to the processed video data so as to verify the authenticity of the processed video data. As discussed herein, the image authentication processing may comprise applying the cryptographic function (e.g., the hash function) to the video data to generate a second unique identifier (e.g., a second hash value) that may be compared to the first unique identifier (e.g., the first hash value) stored in the metadata of the video data. The image authentication processing may further comprise determining whether the first unique identifier matches the second unique identifier. It can be determined that the video data is authentic (e.g., it has not been altered since its generation by the sensor 120) when the first unique identifier matches the second unique identifier. If, however, the first unique identifier is determined to be different from the second unique identifier, it can be determined that the video data is not authentic (e.g., it has been altered).

The system server 140 may store the recognition records, video data, and/or other data in the database for later retrieval, update, modification, deletion, etc. In at least one embodiment, the system server 140 transmits the recognition records, video data, and/or other data, via the network 160, to a third-party server (not shown), which may be one or more servers of law-enforcement (e.g., police, highway patrol, sheriff, etc.), civil service (e.g., department of transportation, municipality, etc.), and private (e.g., trucking company, security, etc.) entities.

The system server 140 may include one or more software applications, stored in the memory, which (when executed by the processor) configures the server computer to host and/or otherwise support one or more digital platforms 146. The digital platform 146 may be an online platform (e.g., a website) or a local platform (e.g., a closed computer network).

The digital platform may include a video management platform, which may be generally configured to permit users, via the user devices 180, to interact with the video data and/or other data stored by the system server 140. In particular, the video management platform 146 may support a graphical user interface 148 that permits users to select and retrieve video data (captured by the sensors 120) for video playback via the user device 180. In some embodiments, the video playback may be substantially up to real-time, or live-stream, video playback.

The graphical user interface 148 may also enable one or more playback functions, including but not limited to permitting users to pause, rewind and fast-forward the video playback. The graphical user interface 148 may further permit other interactions, which may include, for example, object recognition (e.g., license plate recognition, vehicle recognition, etc.), object tagging, video frame notations, data analytics, hit list comparison, and/or smart search capabilities.

The user devices 180 are generally computing devices, and may include mobile (e.g., laptop computer, tablet computer, smartphone, PDA, wearable, etc.) or stationary (e.g., desktop computer, etc.), multi-purpose or dedicated, devices configured to communicate data and information with the system server 140. The user devices 180 may include components typically associated with such devices, such as one or more processors, physical memories, software instructions, data, displays, and interfaces. The user devices 180 may further include one or more software applications, stored in memory, which software applications, when executed by the processor, configures the user devices 180 to function as described herein. In particular, the user devices 180 are configured to allow the users to interact with the digital platforms 146, as described herein.

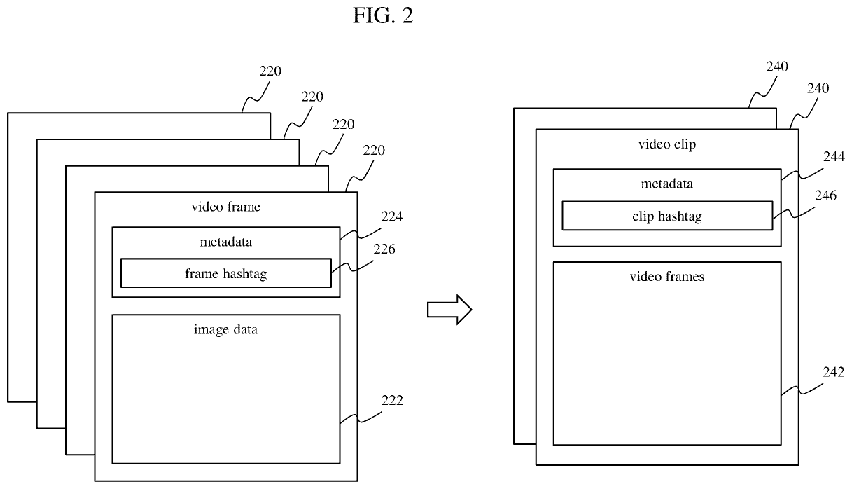

FIG. 2 schematically illustrates exemplary processed video data 200 generated by the sensors 120 and transmitted to the system server 140, in accordance with the embodiment(s) discussed herein. The processed video data 200 may comprise one or more image frames 220 and/or video clips 240.

In at least one embodiment, each image frame 220 comprises image data 222 reflecting an image captured by the imaging device 122. Each image frame may also comprise frame metadata 224 that includes a unique frame identifier 226. The frame metadata 244 may be stored in a header (not shown) of the image frame 220. The unique frame identifier 226 may be generated by applying a cryptographic function, such as a hash function or other deterministic one-way cryptographic algorithm, to the image data 222. Accordingly, the frame identifier 226 may act as a cryptographic signature for the associated image frame 220.

As the image data 222 of each image frame 220 is unique, the resulting frame identifier 226 for the image frame 220 will likewise be unique. However, due to the properties of the deterministic and one-way properties of the cryptographic function, applying the cryptographic function to the same image data 222 will result in the same frame identifier 226. Thus, it may be determined whether the image data 222 of an image frame 220 has been tampered with by later applying the cryptographic function to the image data 222 and comparing the resulting frame identifier 226 with the frame identifier 226 stored in the frame metadata 224.

In at least one embodiment, each video clip 240 comprises a set of sequential image frames 242, with each image frame 220 having image data 222 reflecting respective images that when displayed in sequence constitute a corresponding video. The set of sequential image frames is generally referred to herein by numeral 242, whereas the individual image frames are generally referred to herein by numeral 220. Each video clip 240 may also comprise clip metadata 244 that incudes a unique clip identifier 246. The clip metadata 244 may be stored in a header (not shown) of the video clip 240. The unique clip identifier 246 may be generated by applying a cryptographic function, such as a hash function or other deterministic one-way cryptographic algorithm, to the set of image frames 242 comprising the video clip 240. Accordingly, the clip identifier 246 may act as a cryptographic signature for the associated video clip 240.

As the sequence and make-up of the set of image frames 242 is unique, the resulting clip identifier 246 for the video clip 240 will likewise be unique. However, due to the properties of the deterministic and one-way properties of the cryptographic function, applying the cryptographic function to the same set of image frames 242 will result in the same clip identifier 246. Thus, it may be determined whether the order and/or make-up of the video clip 240 has been tampered with by later applying the cryptographic function to the set of image frames 242 and comparing the resulting clip identifier 246 with the clip identifier 246 stored in the clip metadata 244.

It will be understood that the image frames 220 comprising the set of sequential image frames 242 of the video clip 240 may themselves include unique frame identifiers. However, embodiments are expressly contemplated in which they do not.

In some embodiments, the cryptographic functions used to generate the identifiers 226, 246 may be the same cryptographic function or different cryptographic functions. In at least one embodiment, each set of one or more sensors 120 may utilize its own cryptographic function, or otherwise use its own public/private keys generated from a central certificate stored by the system server 140. The general use of public/private keys with cryptographic functions to generate unique identifiers is known in the art and is not described here in detail. The system server 140 may store the cryptographic functions used to generate the identifiers 226, 246 and/or the central certificate and/or the public/private keys in the storage device 144.

The processed video data 200 may be transmitted to the system server 140 and there authenticated by the image authentication engine 143. In particular, the image authentication engine 143 may (similar to the sensor 120) generate the unique frame identifier 226 from the image data 222 of the received image frames 220 and/or the unique clip identifier 246 from the set of image frames 242 of the received video clip 240. In other words, the digital signatures may be re-calculated by the system server 140.

The re-calculated digital signatures may then be compared to the corresponding digital signatures stored in the frame metadata 224 and/or clip metadata 244 to determine whether the digital signatures match. At the image frame level, the matching digital signatures ensures that the image data of the frame has not been modified since the frame identifier was recorded in the frame metadata. Thus, frame level validation that the image frame has not been modified (e.g., by deep fake technology) is provided.

Similarly, at the clip level, the matching digital signatures ensures that the order and/or make-up of the set of image frames has not been modified since the clip identifier was recorded in the clip metadata. Thus, clip level validation that the image order and/or make-up of the set of image frames has not been modified (e.g., by deep fake technology) is provided.

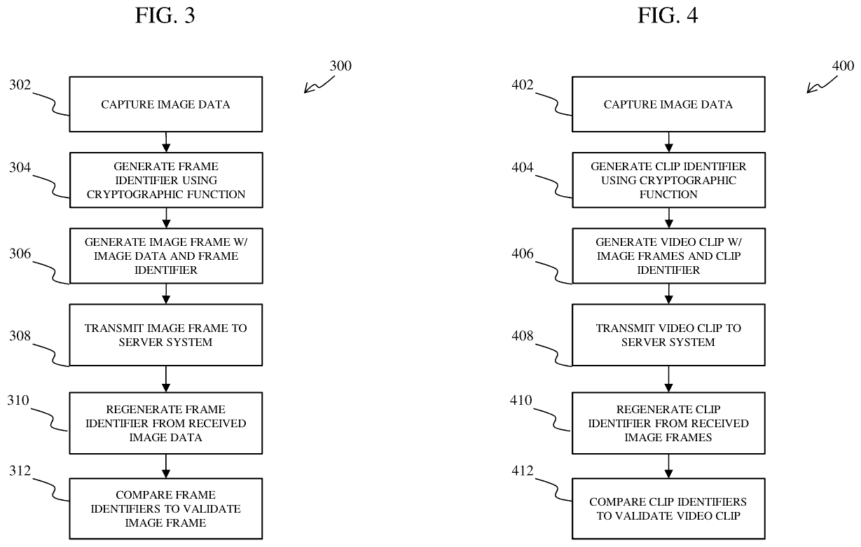

FIG. 3 is a flow-chart that represents an exemplary method 300 in accordance with one or more aspects of the invention.

At step 302, the traffic sensor 120 (or other image capturing device) may capture images of objects and/or surroundings, e.g., vehicle traffic, namely, video images of passing vehicles, and generate video data, including image data, therefrom. The video data may include one or more image frames having image data 222 and frame metadata 224.

At step 304, the image data of the image frame may be processed so as to generate the unique frame identifier 226. The unique frame identifier 226 may be generated by applying a cryptographic function, such as a hash function or other deterministic one-way cryptographic algorithm, to the image data 222.

At step 306, the unique frame identifier 226 may be stored or otherwise recorded in the frame metadata 224 of the image frame 220. Accordingly, the image frame 220 may be generated so as to comprise the image data 222 and the frame metadata 224 including the frame identifier 226. The frame identifier 226 thus may act as a digital signature for the image frame 220.

At step 308, processed video data 200, including the image frame 220, may be transmitted to the system server 140 (or another recipient) to be authenticated. The authentication may be via the image authentication engine 143.

At step 310, the system server 140 (or other recipient) may re-generate the unique frame identifier 226 from the image data 222 of the received image frame 220. In other words, the digital signature may be re-calculated by the system server 140 (or other recipient) from the image data 222 of the received image frame 220.

At step 312, the re-calculated digital signature may be compared to the corresponding digital signature stored in the frame metadata 224 to determine whether the digital signatures match. The matching digital signatures ensures that the image data of the image frame has not been modified since the frame identifier was recorded in the frame metadata. Thus, frame level validation that the image frame has not been modified (e.g., by deep fake technology) is provided.

FIG. 4 is a flow-chart that represents an exemplary method 400 in accordance with one or more aspects of the invention.

At step 402, the traffic sensor 120 (or other image capturing device) may capture images of objects and/or surroundings, e.g., vehicle traffic, namely, video images of passing vehicles, and generate video data, including image data, therefrom. The video data may include one or more image frames having image data and frame metadata, as well as one or more video clips with each video clip having a set of sequential image frames 242 and clip metadata 244.

At step 404, the video clip may be processed so as to generate the unique clip identifier 246. The unique clip identifier 246 may be generated by applying a cryptographic function, such as a hash function or other deterministic one-way cryptographic algorithm, to the set of image frames 242 of the video clip 240.

At step 406, the unique clip identifier 246 may be stored or otherwise recorded in the clip metadata 244 of the video clip 240. Accordingly, the video clip 240 may be generated so as to comprise the set of image frames 242 and the clip metadata 244 including the clip identifier 246. The clip identifier 246 thus may act as a digital signature for the video clip 240.

At step 408, processed video data 200, including the video clip 240, may be transmitted to the system server 140 (or another recipient) to be authenticated. The authentication may be via the image authentication engine 143.

At step 410, the system server 140 (or other recipient) may re-generate the unique clip identifier 246 from the set of image frames 242 of the received video clip 240. In other words, the digital signature may be re-calculated by the system server 140 (or other recipient) from the set of image frames 242 of the received video clip 240.

At step 412, the re-calculated digital signature may be compared to the corresponding digital signature stored in the clip metadata 244 to determine whether the digital signatures match. The matching digital signatures ensures that the set of image frames 242 of the received video clip 240 has not been modified since the clip identifier was recorded in the clip metadata. Thus, clip level validation that the video clip has not been modified (e.g., by deep fake technology) is provided.

It will be understood that the principles of the invention are not limited to implementation in traffic monitoring systems. For example, the principles of the invention may be analogously applied to a system comprising one or more sensors (e.g., smartphones and other mobile devices) configured to capture images/video of the surrounding environment for uploading to a system server (or other device) that stores or otherwise distributes or displays the images/video. Thus, the principles of the invention may be more generally applied to any system in which image/video authentication is desired-without regard to whether the images/video is for traffic monitoring purposes.

The embodiments described in detail above are considered novel over the prior art and are considered critical to the operation of at least one aspect of the described systems, methods and/or apparatuses, and to the achievement of the above described objectives. The words used in this specification to describe the instant embodiments are to be understood not only in the sense of their commonly defined meanings, but to include by special definition in this specification: structure, material or acts beyond the scope of the commonly defined meanings. Thus, if an element can be understood in the context of this specification as including more than one meaning, then its use must be understood as being generic to all possible meanings supported by the specification and by the word or words describing the element.

The definitions of the words or drawing elements described herein are meant to include not only the combination of elements which are literally set forth, but all equivalent structure, material or acts for performing substantially the same function in substantially the same way to obtain substantially the same result. In this sense, it is therefore contemplated that an equivalent substitution of two or more elements may be made for any one of the elements described and its various embodiments or that a single element may be substituted for two or more elements.

Changes from the subject matter as viewed by a person with ordinary skill in the art, now known or later devised, are expressly contemplated as being equivalents within the scope intended and its various embodiments. Therefore, obvious substitutions now or later known to one with ordinary skill in the art are defined to be within the scope of the defined elements. This disclosure is thus meant to be understood to include what is specifically illustrated and described above, what is conceptually equivalent, what can be obviously substituted, and also what incorporates the essential ideas.

Furthermore, the functionalities described herein may be implemented via hardware, software, firmware or any combination thereof, unless expressly indicated otherwise. If implemented in software, the functionalities may be stored in a memory as one or more instructions on a computer readable medium, including any available media accessible by a computer that can be used to store desired program code in the form of instructions, data structures or the like. Thus, certain aspects may comprise a computer program product for performing the operations presented herein, such computer program product comprising a computer readable medium having instructions stored thereon, the instructions being executable by one or more processors to perform the operations described herein. It will be appreciated that software or instructions may also be transmitted over a transmission medium as is known in the art. Further, modules and/or other appropriate means for performing the operations described herein may be utilized in implementing the functionalities described herein.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the described embodiments and equivalents thereof.

1. An image data validation system, comprising:
an image source configured to:
capture an image of an object,
generate, from the captured image, image data and associated metadata, wherein the metadata stores a first unique identifier generated by applying a cryptographic function to the image data, and
transmit the image data and the metadata; and
an image recipient configured to:
receive the image data and the metadata from the image source,
generate a second unique identifier from the image data by applying the cryptographic function to the image data, and
validate the image data by comparing the first unique identifier to the second unique identifier.

2. The system of claim 1, wherein the validation system is integrated in a traffic monitoring system such that the image source comprises a traffic sensor and the image recipient comprises a traffic monitoring server system.

3. The system of claim 1, wherein the image data is validated as having not been altered where the first unique identifier matches the second unique identifier.

4. The system of claim 1,
wherein the cryptographic function is a hash function, and
wherein the first/second unique identifiers are hash values.

5. The system of claim 1, wherein the image data is of an image frame.

6. The system of claim 1,
wherein the image data is of a set of sequential image frames, and
wherein the first/second unique identifiers are generated by applying the cryptographic function to the set of image frames.

7. A method for validating image frames, comprising:
generating, from a captured image and at a source of the captured image, an image frame comprising image data and associated metadata, wherein the metadata includes a first unique identifier generated by applying a cryptographic function to the image data;
receiving the image frame at a recipient; and
validating, by the recipient, the image data of the image frame by:
generating a second unique identifier by applying the cryptographic function to the image data, and
comparing the first unique identifier to the second unique identifier, wherein the image frame is validated as having not been altered where the first unique identifier matches the second unique identifier.

8. The method of claim 7,
wherein the source is a traffic sensor of a traffic monitoring system, and
wherein the image recipient is a traffic monitoring server system.

9. The method of claim 7,
wherein the cryptographic function is a hash function, and
wherein the first/second unique identifiers are hash values.

10. A method for validating video clips, comprising:
generating, from captured video and at a source of the captured video, a video clip and associated metadata, wherein the video clip comprises a set of sequential image frames having associated image data, and wherein the metadata includes a first unique identifier generated by applying a cryptographic function to the set of image frames;
receiving the video clip at a recipient; and
validating, by the recipient, the image data of the video clip by:
generating a second unique identifier by applying the cryptographic function to the set of image frames, and
comparing the first unique identifier to the second unique identifier, wherein the video clip is validated as having not been altered where the first unique identifier matches the second unique identifier.

11. The method of claim 10,
wherein the source is a traffic sensor of a traffic monitoring system, and
wherein the image recipient is a traffic monitoring server system.

12. The method of claim 10,
wherein the cryptographic function is a hash function, and
wherein the first/second unique identifiers are hash values.
